(19) United States
(12) Patent Application Publication
(10) Pub. No.: US 2026/0082435 A1
(43) Pub. Date: Mar. 19, 2026

(54) NETWORK COEXISTENCE AIRTIME SHARING

(71) Applicant: Cypress Semiconductor Corporation, San Jose, CA (US)

(72) Inventors: Sandeep Sarma Munukutla, Bangalore (IN); Suprojit Mukherjee, Nadia (IN); Raghavendra Kencharla, Bangalore (IN); Ayush Sood, Bengaluru (IN)

(73) Assignee: Cypress Semiconductor Corporation, San Jose, CA (US)

(21) Appl. No.: 18/890,588

(22) Filed: Sep. 19, 2024

(51) Int. Cl. H04W 74/0833; H04B 17/309; H04L 1/00; H04W 84/12

(52) U.S. Cl. CPC H04W 74/085; H04B 17/346; H04L 1/0061; H04W 84/12

(57) ABSTRACT

Technologies related to network coexistence is described. A wireless personal area network (WPAN) module receives a first message with a length value corresponding to a length of the first message. A wireless local area network (WLAN) module obtains the length value. The WLAN module sends a second message over the WLAN that prevents other devices from sending traffic over the WLAN for an amount of time based on the length value.

### BACKGROUND

Various wireless devices may transmit/receive data according to any of various communication protocols. For example, a wireless device can transmit/receive signals using the Wi-Fi® protocol, the Bluetooth® protocol, or the WiMAX® protocol, among others. In some cases, multiple transceivers can be implemented in a single multi-protocol combination device and can share other system resources, such as transmission medium. For example, a single device can include a Bluetooth® transceiver as well as a wireless local area network (WLAN) transceiver (operating with the Wi-Fi® protocol, for example), which may both at least partially share a common wireless transmission medium (e.g., a radio frequency (RF) band, such as 2.4 gigahertz (GHz) band).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless device having scheme logic and wireless local area network (WLAN) and wireless personal area network (WPAN) capabilities, according to one embodiment.

FIG. 2 depicts an exemplary graph illustrating a series of clear-to-send to self (CTS-2-self) messages by a WPAN central device with WLAN capabilities, according to one embodiment.

FIG. 3 depicts an exemplary graph illustrating a series of clear-to-send to self (CTS-2-self) messages by a WPAN peripheral device with WLAN capabilities, according to one embodiment.

FIG. 4 is a diagram illustrating in-band leakage interference of transmitted WLAN signals during a WPAN operational cycle, according to one embodiment.

FIG. 5 is a flowchart illustrating scheme enablement logic, according to one embodiment.

FIG. 6 depicts an exemplary graph illustrating outcomes of the scheme enablement logic, according to one embodiment.

FIG. 7 illustrates a process of encryption, cyclic redundancy check (CRC) generation, and data whitening from transmit (TX) and receive (RX) sides of a wireless communication, according to one embodiment.

FIG. 8 illustrates a linear feedback shift register (LFSR) of a data whitening process, according to one embodiment.

FIG. 9 illustrates a method in accordance with one embodiment.

FIG. 10 is a block diagram illustrating a wireless device, according to one embodiment.

### DETAILED DESCRIPTION

Technologies related to network coexistence is described. Network coexistence allows different types of networks, such as Wireless Local Area Networks (WLAN) and Wireless Personal Area Networks (WPAN), to operate side-by-side. As field-of-view (FOV) and frequency of networks can routinely overlap, operations designed to allow these networks to share airtime—and thus avoid undue interference—can be desired. However, conventional network coexistence operations routinely underprotect or overprotect network operational cycles, which can lead to unintelligible data or unutilized airtime, respectively. Underprotection in this scenario refers to insufficient mechanisms in place to prevent overlap between WLAN and WPAN signals. In other words, underprotection can occur when a network's operational cycle is shorter than needed. Underprotection in the context of network coexistence can significantly impair the functionality and performance of networks operating in close proximity. This lack of adequate protection measures can lead to interference, where the signals from different networks overlap, causing data loss, reduced transmission rates, and increased latency. In environments where multiple networks coexist underprotection can diminish the overall efficiency and reliability of these networks. Additionally, underprotection can give devices of the network a false impression that a connection is weak (when in fact underprotection is the true culprit), which can unintentionally reduce network throughput by causing devices of the network to lower a modulation and coding scheme (MCS) rate of the network.

Overprotection, on the other hand, involves implementing overly stringent measures that limit the effective use of the radio frequency (RF) spectrum and network resources, thereby reducing the operational efficiency and potential throughput of both networks. In other words, overprotection can occur when a network's operational cycle is longer than needed. By implementing overly cautious protection measures, one of the coexisting networks may utilize a larger portion of the spectrum or resources than necessary, leaving less airtime for other coexisting networks. This can stifle the other coexisting networks and limit the capacity for new services or higher throughput. Relatedly, overprotection may result in reduced network density and coverage, as networks are forced to operate with greater separation than technically required. While overprotection may be more desirable than underprotection, this conservative approach can unnecessarily elevate the costs associated with network deployment and operation, impacting the affordability and accessibility of network services for end users.

Aspects and embodiments of the present disclosure overcome these deficiencies and others by providing a scheme with a variable amount of protection for a coexisting network. Aspects and embodiments of the present disclosure reduce or eliminate both underprotection and overprotection for a coexisting network. While the present disclosure provides examples and processes related to a coexisting protocols and their corresponding networks (e.g., a coexisting WLAN and a coexisting WPAN), the principles and features provided herein may be applied to other types of coexisting networks (or coexisting protocols) that are at risk of causing in-band interference that degrades the performance of either network. Such coexisting networks may include, but are not limited to, cellular networks, long range wide area networks (LoRaWAN), industrial, scientific, and medical (ISM) band networks, Wi-Fi®, high performance radio local area network (HiperLAN), worldwide interoperability for microwave access (WiMAX®), Zigbcc®, Bluetooth®, Bluetooth low energy (BLE®), Zigbee®, Thread®, wireless universal serial bus (WUSB®), and their corresponding protocols.

Aspects and embodiments of the present disclosure provide a first wireless device with a WLAN module and a WPAN module. With these WLAN and WPAN modules, this first wireless device may have both WLAN and WPAN communication functionality, and thus may switch between WLAN and WPAN operational cycles using coexistence scheme logic. The first wireless device may receive a first message over the WPAN from a second wireless device. This first message may include a payload. The first message may include a length value that indicates a length of the first message. This length value may be received by a WPAN module. This length value may be obtained by a WLAN module. The WLAN module may cause a second message to be sent to a third wireless device. This second message may prevent the third wireless device from sending traffic over the WLAN for an amount of time based on the length value. In at least one embodiment, this second message may be a Clear To Send to Self (CTS-2-Self) message. A CTS-to-Self message is a control frame in wireless networking that a device sends to reserve the airtime and notify other devices to refrain from transmitting.

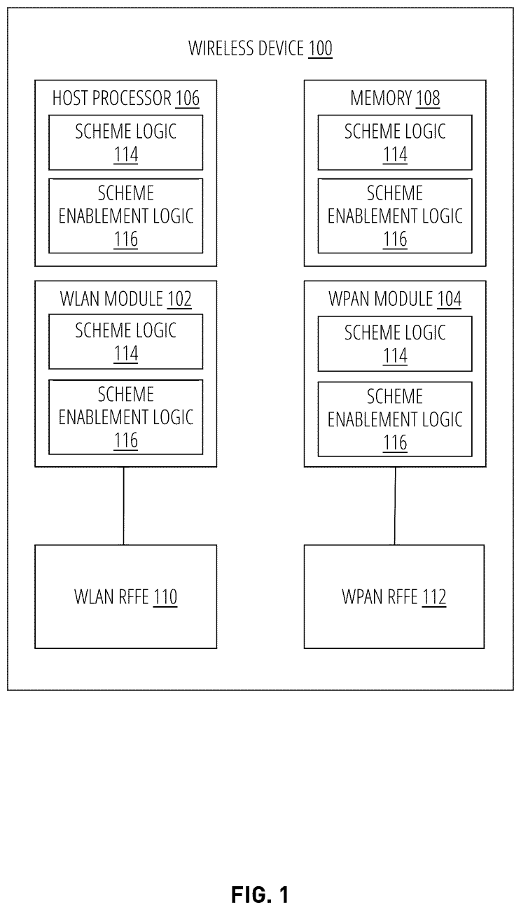

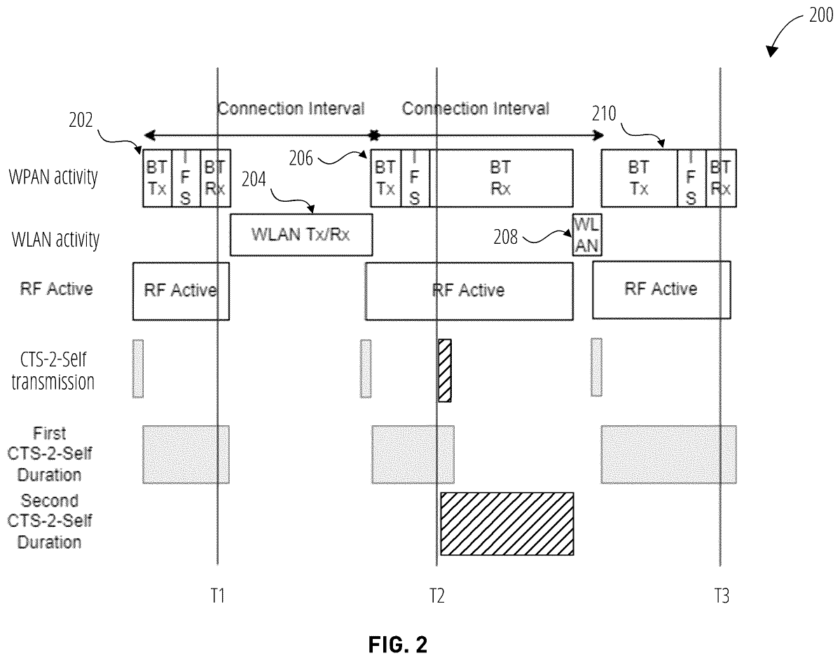

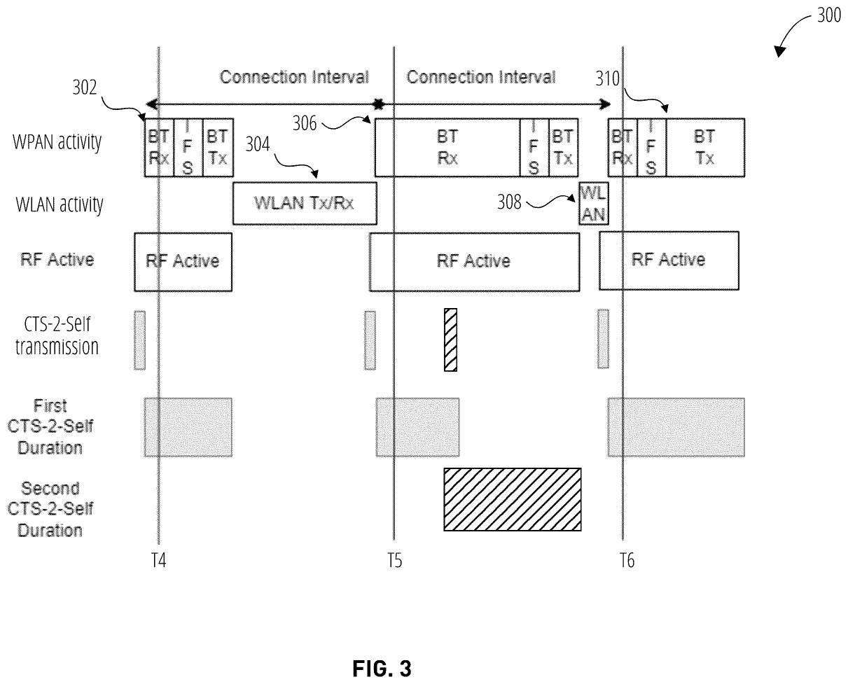

FIG. 1 illustrates a wireless device 100 having scheme logic 114 and wireless local area network (WLAN) and wireless personal area network (WPAN) capabilities, according to one embodiment. FIGS. 2-3 provide examples of how the scheme logic 114 may operate within a WPAN central device (also referred to as a principal, primary, or leader device) or a WPAN peripheral device (also referred to as a secondary or follower device), respectively. The wireless device 100 may include a WLAN module 102 and a WPAN module 104. These WLAN and WPAN modules 102, 104 may operate using different protocols. For example, the WLAN module 102 may communicate over a WLAN using a first protocol, and the WPAN module may communication over a WPAN using a second protocol different from the first protocol. The described operations of the WLAN and WPAN modules 102, 104 may, at least partially, describe their respective protocols. The WLAN module 102 may enable the wireless device 100 to connect to a wireless network, allowing it to communicate with other devices and access the internet without the need for physical cables. The WLAN module 102 may encompass hardware and software components that support various wireless communication standards. The WLAN module 102 may be configured to transmit and receive data via a radio frequency front end (RFFE) configured for the WLAN (i.e., WLAN RFFE 110). The WPAN module 104 may be configured to enable short-range wireless communication between devices within a smaller area. Devices part of a WPAN may include smartphones, tablets, wearables (such as smartwatches or fitness trackers), peripherals (such as keyboards, mice, headphones), or internet of things (IoT) devices (such as cameras, speakers, motion detectors, digital locks, smart thermostats, smart home assistants, or other IoT-enabled applications or appliances). The WPAN module 104 may encompass hardware and software components that support various wireless communication standards, the WPAN module 104 may be configured to transmit and receive data via a RFFE configured for the WPAN (i.e., WPAN RFFE 112). The WPAN RFFE 112 may include at least a low noise amplifier (LNA), a mixer, and a band pass filter (BPF). The WPAN RFFE 112 may have an associated gain.

The wireless device 100 may also include a host processor 106 and memory 108. The memory 108 may store instructions that, if executed by the host processor 106, causes the host processor 106 to interact with one or more of the WLAN module 102 or WPAN module 104 for various reasons. In at least one embodiment, the host processor 106 may handle data to be transmitted over one of the networks and process incoming data from the networks. Incoming or outgoing data may be stored within the memory 108. The host processor 106 may also be involved with managing the WLAN and the WPAN and handling connections and disconnections to other networks or devices. The host processor 106 may also manage network settings or profiles for the WLAN or WPAN. The host processor 106 may also monitor diagnostics of the networks and initiate any corrective measures in response to discovery of errors or inefficiencies related to the networks.

In some embodiments, the wireless device 100 may include scheme logic 114 that, if performed, causes the wireless device 100 to execute a first coexistence process. Operations of the scheme logic 114 may be distributed among different portions of the wireless device 100. In at least one embodiment, at least each of the WLAN module 102 and the WPAN module 104 may perform operations of the scheme logic 114. Instructions related to the scheme logic 114 may be stored in memory internal to the WLAN module 102 and WPAN module 104 or within the memory 108. The host processor 106 may perform at least a portion of the operations of the scheme logic 114.

Generally, coexistence processes are designed to allow two types of wireless networks to operate in close proximity without causing significant interference to each other. In many cases, a coexistence process may use time division multiplexing (TDM) techniques to separate the different networks, which effectively causes the different networks to share airtime. Sharing airtime can be particularly important where different networks operate in the same frequency bands, as in-band interference caused by simultaneous signal transmittal in the networks can cause complete packet loss in both networks. In at least one embodiment, the first coexistence process may be a TDM process that causes the different networks (as illustrated in exemplary FIG. 1, WLAN and WPAN) to share airtime. Periods of time where WLAN communication is allocated by the first coexistence process may be referred to as WLAN operational cycles, and periods of time where WPAN communication is allocated by the first coexistence process may be referred to as WPAN operational cycles.

In some embodiments, the scheme logic 114 may utilize capabilities of the WLAN to prevent data traffic of the WLAN from being transmitted during a WPAN operational cycle. In at least one of these embodiments, the scheme logic 114 may use Clear to Send to Self (CTS-2-Self) frame(s) to prevent devices part of the WLAN from transmitting during WPAN operational cycles. A CTS-2-Self frame in a wireless network is a control frame sent by a wireless device to itself, indicating that the medium is clear for it to send data, effectively reserving the medium within the WLAN. In at least one embodiment, CTS-2-Self frames work by setting the Network Allocation Vector (NAV) in nearby WLAN devices, informing them to wait for the specified duration before attempting to transmit. NAVs of WLAN devices may be set based on a duration value part of the CTS-2-Self frame. In these embodiments, once the scheme logic 114 knows when a WPAN operational cycle is to begin (and thus a WLAN operational cycle is to end), the scheme logic 114 may cause the WLAN module 102 to transmit CTS-2-Self frame(s) over the WLAN, which effectively causes the WLAN to share airtime with the WPAN for at least the duration set in the NAV. In some embodiments, the scheme logic 114 may utilize capabilities of the WPAN, such as capabilities similar to the CTS-2-Self frame as described herein, to prevent data traffic of the WPAN from being transmitted during a WLAN operational cycle.

The scheme logic 114 may cause a first CTS-2-Self frame with a first duration value to be sent over the WLAN at the beginning of a WPAN operational cycle, and optionally send a second CTS-2-Self frame with a second duration value over the WLAN at a later time during the same WPAN operational cycle. The first duration value of the first CTS-2-Self frame may set the NAV of other devices part of the WLAN according to a minimum amount of time of the WPAN operational cycle. This minimum amount of time may correspond to (i) a known length of a transmit (TX) WPAN packet and (ii) a known length of a receive (RX) WPAN packet. The TX WPAN packet may be a TX packet sent by the WPAN module 104, and the RX WPAN packet may be an RX packet received by the WPAN module 104. This second known duration may be a minimum possible length for a WPAN packet. A minimum possible length for a WPAN packet may be a WPAN packet with an empty payload. The second duration value of the second CTS-2-Self frame may set the NAV of other devices part of the WLAN according to a remainder length of the RX WPAN packet. This remainder length may correspond to portion beyond a minimum length of the RX WPAN packet. In at least one embodiment, this remainder length may include a size of payload of the WPAN packet. In at least some of these embodiments, the first duration value may account for the known length of RX WPAN packet, while the second duration value accounts for parts of the RX WPAN packet that have an unknown length at the time that the first CTS-2-Self frame is transmitted. The known length of the RX WPAN packet may include lengths of portions of the WPAN packet besides the payload length, such as a WPAN header length and a WPAN message integrity check (MIC) footer length. The unknown length of the RX WPAN packet may include variable lengths of portions of the WPAN packet, such as the payload. Each WPAN packet may include a header that has a length value that indicates its length. This length may be indicated in bits, bytes, total number of symbols, or the like. An example of this header with respect to a BLE® WPAN is shown in the below table (1):

TABLE 1

| LLID | NESN | SN | MD | CP | RFU | Length | CTEInfo |
|---|---|---|---|---|---|---|---|
| 2 bits | 1 bit | 1 bit | 1 bit | 1 bit | 2 bits | 8 bits | 8 bits |

The header of table (1) has two logic link identifier (LLID) bits, one next expected sequence number (NESN) bit, one sequency number (SN) bit, one more data (MD) bit, one control packet (CP) bit, two bits reserved for future use (RSU), eight length bits, and eight constant tone extension information (CTEInfo) bits. These eight length bits correspond to a length value of the packet. This length value may correspond to the number of bytes of the payload (e.g., 0-255 bytes). Packet headers of other types of WPANs may have similar length values that indicate a length of the packet's payload. By identifying this length value, the scheme logic 114 can determine what the remainder amount of time should be to avoid underprotecting or overprotecting the WPAN operational cycle. Once this length value is known to the WPAN module 104, the second duration value may be determined by the scheme logic 114 using the length value. In other words, the second duration value may be based on the length value. In some embodiments, the scheme logic 114 may cause the WPAN module 104 to share the length value (or the second duration value) with the WLAN module 102 via general communication interface (GCI) bits or through other techniques that may involve the WLAN module 102 and WPAN module 104 part of an integrated chipset, shared memory, middleware software, application layer solutions, a unified application programming interface (API), or any other suitable technique that can quickly share information between the WLAN module 102 and the WPAN module 104. In at least one embodiment, the WLAN module 102 may obtain the length value from the WPAN module 104 before the minimum amount of time expires on the NAV(s) of the other WLAN device(s).

In some cases, the length value of a RX WPAN packet may not be precise. Cyclic redundancy checks (CRCs) may be regularly performed in order to predict when the length value will not be precise. CRCs can be used for detecting errors in data and verifying the integrity of data during transmission. A CRC can begin with a string of data, which is treated as a large binary number. A predetermined polynomial, also expressed as a binary number, may be chosen as the divisor for the CRC algorithm. To perform the CRC, the data string is appended with a series of zeros equal to one less than the length of the polynomial. This extended data string is then divided by the polynomial using binary division. Binary division is a process similar to long division that involves XOR operations instead of subtraction. A remainder obtained from this division process is the CRC value. This remainder is often referred to as a “checksum” and is appended to the original data before transmission. After transmission, when the packet is received, the same polynomial is used to divide the combined data string. The combined data strong may include the original data plus the checksum. If the remainder of this division is zero, it indicates that the data has not been corrupted; otherwise, it signifies that there has been an error in the data. This remainder may be referred to as a CRC value or CRC status, which can indicate whether the length value is (i) accurate or (ii) not entirely accurate due to corruption during transmission. The scheme logic 114 may monitor these CRC statuses (also referred to as CRC remainders) to predict whether a next WPAN packet will have an accurate length value. If CRC values of recent historical WPAN packets indicate a weak connection between the wireless device 100 and a second wireless device from which WPAN packets are received, the scheme logic 114 may cause the second duration value to be equal to something different than the remainder length of the RX WPAN packet. These recent historical CRC values may each correspond to a different historical packet received from the second wireless device. In one embodiment, if recent historical CRC values corresponding to historical packets (also referred to as historical messages) received from the second wireless device cause the scheme logic 114 to predict that the RX WPAN packet has been corrupted during transmission, the scheme logic 114 may cause the second duration value to represent the remainder length of the RX WPAN packet combined with a historical CRC error value. This historical CRC error value may be any combination or average of one or more recent historical CRC values.

In some embodiments, the wireless device 100 may include the scheme enablement logic 116 that determine whether the coexistence process implemented by the scheme logic 114 should be used. Operations of the scheme enablement logic 116 may be distributed among different portions of the wireless device 100. In at least one embodiment, at least each of the WLAN module 102 and the WPAN module 104 may perform operations of the scheme logic 114. Instructions related to the scheme logic 114 may be stored in memory internal to the WLAN module 102 and WPAN module 104 or within the memory 108. The host processor 106 may perform at least a portion of the operations of the scheme logic 114.

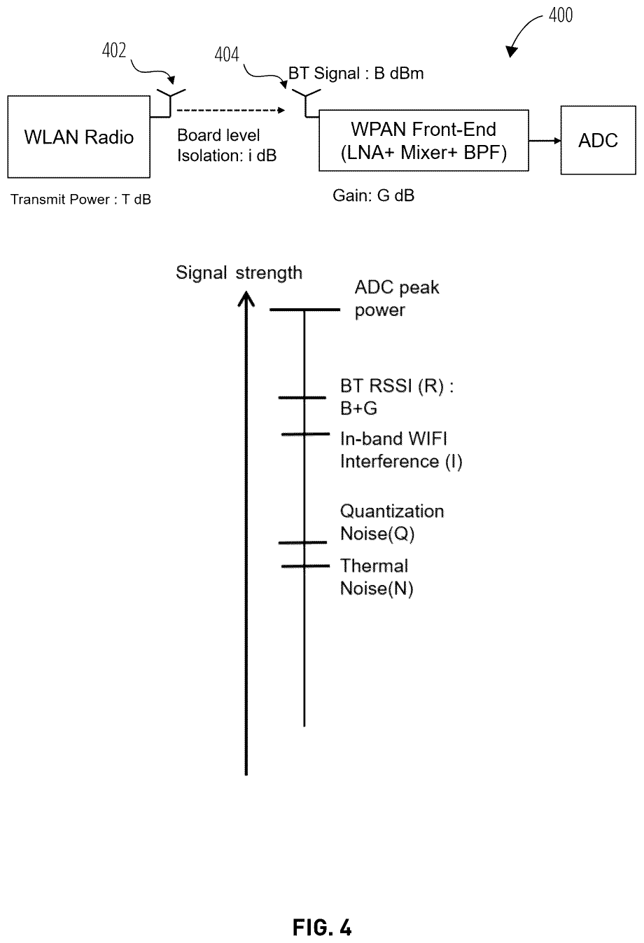

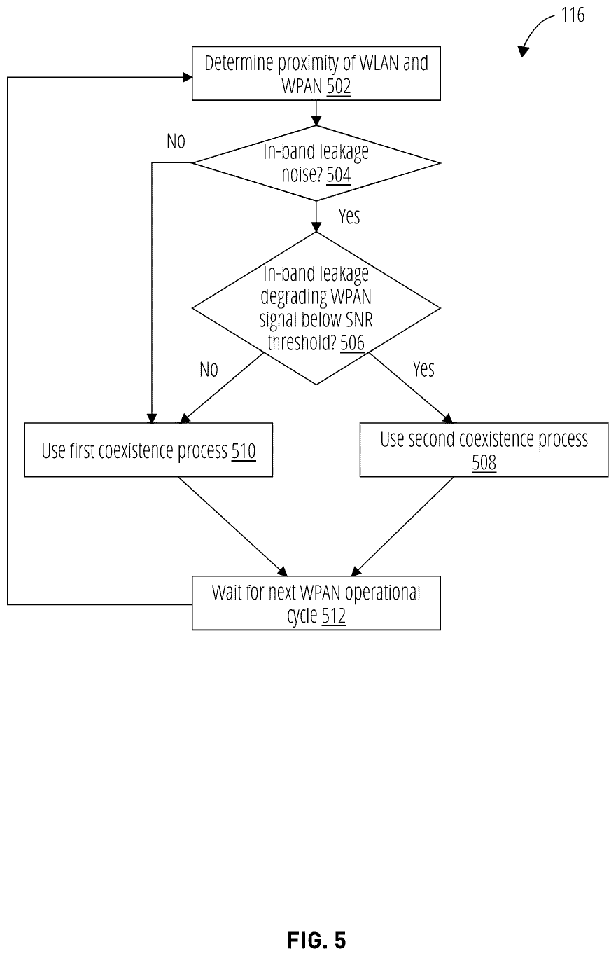

Each time that a WPAN operational cycle begins, the scheme enablement logic 116 may determine whether the coexistence process implemented by the scheme logic 114 or a different coexistence process should be used. To do so, the scheme enablement logic 116 may analyze whether transmitting a CTS-2-Self frame would cause significant interference within the WPAN. Part of this analysis may be determining whether the CTS-2-Self frame will cause in-band leakage noise which would have a significant chance of rendering the RX WPAN packet unintelligible. This analysis is described in more detail below with respect to FIG. 5. The scheme enablement logic 116 may calculate a signal to noise ratio (SNR) value based on characteristics of WPAN and WLAN channel/frequency characteristics, isolation characteristics between TX/RX antennas used by the WPAN and WLAN modules 102, 104, thermal noise, quantization noise, and gain characteristics of the WPAN RFFE 112. In at least one embodiment, the SNR ratio may be indicative of interference between the WLAN and WPAN. The calculation of this SNR value is described in more detail below with respect to FIG. 4.

Historical CRC values may also be tracked by the scheme enablement logic 116. The scheme enablement logic 116 determine whether the coexistence process implemented by the scheme logic 114 should be enabled for a current WPAN operational cycle based on the historical CRC values. In some embodiments, the scheme enablement logic 116 may determine whether the coexistence process implemented by the scheme logic 14 should be enabled for the current WPAN operational cycle by comparing the historical CRC error value (a combination of recent historical CRC values) to a CRC threshold. If the scheme enablement logic 116 to predict that a next RX WPAN packet will likely be corrupted during transmission, the scheme enablement logic 116 may cause a different coexistence process to be implemented (i.e., not use the scheme logic 114). If the scheme enablement logic 116 does not predict that the next RX WPAN packet is not likely to be corrupted during transmission, the scheme enablement logic 116 may enable the scheme logic 114 during the current (or upcoming) WPAN operational cycle.

FIG. 2 depicts an exemplary graph 200 illustrating a series of clear-to-send to self (CTS-2-self) messages by a wireless device that is a WPAN central device (e.g., primary or principal device) with WLAN capabilities, according to one embodiment. While the graph 200 uses Bluetooth® (BT®) as an exemplary WPAN, any other type of WPAN or other type of suitable network may be used. The graph 200 illustrates the wireless device (e.g., the wireless device 100) switching between WPAN operational cycles 202, 206, 210 and WLAN operational cycles 204, 208. CTS-2-Self durations may correspond to the WPAN operational cycles. In some embodiments, the wireless device may transmit a first CTS-2-Self frame at the beginning of each WPAN operational cycle and optionally transmit a second CTS-2-Self frame before the respective WPAN operational cycle expires. A duration value of each respective first CTS-2-Self frame may correspond to (i) the known length of the TX WPAN transmission period, (ii) the known length of an inter frame space (IFS) (e.g., 150 microseconds) period, and (ii) the minimum transmission period for any RX WPAN transmission. The length of the TX WPAN transmission period may always be known to the wireless device before respective first CTS-2-Self frames are transmitted. The minimum transmission period for any RX WPAN transmission may correspond to known lengths of portions of a WPAN packet, such as the header (typically 16 or 24 bits), preamble, access address field, and CRC, with the assumption that the RX WPAN packet has an empty payload. In at least some embodiments, if the RX WPAN packet has an empty payload, the RX WPAN will also not have the MIC (typically 32 bits). In some embodiments, the header may encompass the preamble and access address field. A second CTS-2-Self frame may not be sent during either the first or third WPAN operational cycles 202, 210 because their respective RX WPAN packets are received within the minimum transmission period. These respective RX WPAN packets may be received within the minimum transmission period because their respective RX WPAN packets have empty payloads. Conversely, a second CTS-2-Self frame may be transmitted (or sent) during the second WPAN operational cycle 206 because the RX WPAN packet is not received within the minimum transmission period. Here, the RX WPAN packet is not received within the minimum transmission period because the payload of the respective RX WPAN packet is not empty. The duration of the second CTS-2-Self frame, which is the duration set to the NAV of other WLAN devices by the second CTS-2-Self frame, may expire concurrently with the transmission of the RX WPAN packet being completed.

At times T1-T3, the wireless device may receive the length value of respective RX WPAN packets of WPAN operational cycles 202, 206, 210. A first length value processed by a WPAN module (e.g., WPAN module 104) at T1 may indicate that a payload of a first RX WPAN packet of the first WPAN operational cycle 202 is empty, which may indicate that a second CTS-2-Self frame is not needed within the first WPAN operational cycle 202. The second CTS-2-Self frame may not be needed here because the first WPAN operational cycle 202 is covered by the duration of the first CTS-2-Self frame. A second length value processed by the WPAN module at T2 may indicate that a payload of a second RX WPAN packet of the second WPAN operational cycle 206 is not empty, which may cause a second CTS-2-Self frame to be transmitted within the second WPAN operational cycle 206 by a WLAN module (e.g., WLAN module 102) of the wireless device to other devices of the WLAN. The second CTS-2-Self frame may be transmitted here because the second WPAN operational cycle 206 is not covered by the duration of the first CTS-2-Self frame. A third length value processed by the WPAN module at T3 may indicate that a payload of a third RX WPAN packet of the third WPAN operational cycle 210 is empty, which may indicate that a second CTS-2-Self frame is not needed within the third WPAN operational cycle 210, similar to the first WPAN operational cycle 202.

In some cases, WPAN operational cycles may have more than one pair of TX/RX WPAN packets. With respect to wireless devices that are a central WPAN device with WLAN capabilities, the process described may be repeated each time that the wireless device sends a TX WPAN packet over the WPAN. For example, if a second TX WPAN packet is sent within the first WPAN operational cycle 602, a third CTS-2-Self frame may be sent over the WLAN with features similar to the first CTS-2-Self frame, and a fourth CTS-2-Self frame may optionally be sent over the WLAN based on a second length value of a second RX WPAN packet received in response to the second TX WPAN packet. Additionally, if a third TX WPAN packet is sent within the first WPAN operational cycle 602, a fifth CTS-2-Self frame may be sent over the WLAN with features similar to the first CTS-2-Self frame, and a sixth CTS-2-Self frame may optionally be sent over the WLAN based on a third length value of a third RX WPAN packet received in response to the third TX WPAN packet.

FIG. 3 depicts an exemplary graph 300 illustrating a series of clear-to-send to self (CTS-2-self) messages by a wireless device that is a WPAN peripheral device with WLAN capabilities, according to one embodiment. While the graph 300 uses Bluetooth® (BT®) as an exemplary WPAN, any other type of WPAN or other type of suitable network may be used. The graph 300 illustrates the wireless device (e.g., the wireless device 100) switching between WPAN operational cycles 302, 306, 310 and WLAN operational cycles 304, 308. Illustrated CTS-2-Self durations, which represent durations set to the NAVs of other devices of the WLAN, may correspond to the WPAN operational cycles. In some embodiments, the wireless device may transmit a first CTS-2-Self frame at the beginning of each WPAN operational cycle and optionally transmit a second CTS-2-Self frame before the respective WPAN operational cycle expires. A duration value of each respective first CTS-2-Self frame may correspond to (i) the known length of the TX WPAN transmission period, (ii) the known length of an inter frame space (IFS) (e.g., 150 microseconds) period, and (ii) the minimum transmission period for any RX WPAN transmission. The length of the TX WPAN transmission period may always be known to the wireless device before respective first CTS-2-Self frames are transmitted. The minimum transmission period for any RX WPAN transmission may correspond to known lengths of portions of a WPAN packet, such as the header (typically 16 or 24 bits) or the MIC (typically 32 bits). A second CTS-2-Self frame may not be sent during either the first or third WPAN operational cycles 202, 210 because their respective RX WPAN packets are received within the minimum transmission period. These respective RX WPAN packets may be received within the minimum transmission period because their respective RX WPAN packets have empty payloads. Conversely, a second CTS-2-Self frame may be transmitted (or sent) during the second WPAN operational cycle 206 because the RX WPAN packet is not received within the minimum transmission period. The second CTS-2-Self frame may be transmitted here because the payload of the respective RX WPAN packet is not empty. The duration of the second CTS-2-Self frame may expire concurrently with the transmission of the TX WPAN packet.

At times T4-T6, the wireless device may receive the length value of respective RX WPAN packets of WPAN operational cycles 302, 306, 310. A first length value processed by a WPAN module (e.g., WPAN module 104) at T4 may indicate that a payload of a first RX WPAN packet of the first WPAN operational cycle 302 is empty, which may indicate that a second CTS-2-Self frame is not needed within the first WPAN operational cycle 302. The second CTS-2-Self frame may not be needed here because the first WPAN operational cycle 302 is covered by the duration of the first CTS-2-Self frame. A second length value processed by the WPAN module at T5 may indicate that a payload of a second RX WPAN packet of the second WPAN operational cycle 306 is not empty, which may cause a second CTS-2-Self frame to be transmitted within the second WPAN operational cycle 306 by a WLAN module (e.g., WLAN module 102) of the wireless device to other devices of the WLAN. The second CTS-2-Self frame may be transmitted here because the second WPAN operational cycle 306 is not covered by the duration of the first CTS-2-Self frame. A third length value processed by the WPAN module at T6 may indicate that a payload of a third RX WPAN packet of the third WPAN operational cycle 310 is empty, which may indicate that a second CTS-2-Self frame is not needed within the third WPAN operational cycle 310, similar to the first WPAN operational cycle 302.

In some cases, WPAN operational cycles may have more than one pair of RX/TX WPAN packets. With respect to wireless devices that are a peripheral WPAN device with WLAN capabilities, the process described may be repeated each time that the wireless device receives an RX WPAN packet. For example, if a second RX WPAN packet is received within the first WPAN operational cycle 602, a third CTS-2-Self frame may be sent over the WLAN with features similar to the first CTS-2-Self frame, and a fourth CTS-2-Self frame may optionally be sent over the WLAN based on a second length value of the second RX WPAN. Additionally, if a third RX WPAN packet is received within the first WPAN operational cycle 602, a fifth CTS-2-Self frame may be sent over the WLAN with features similar to the first CTS-2-Self frame, and a sixth CTS-2-Self frame may optionally be sent over the WLAN based on a third length value of the third RX WPAN packet.

FIG. 4 is a diagram 400 illustrating in-band leakage interference of transmitted WLAN signals during a WPAN operational cycle, according to one embodiment. In at least some scenarios, a proximity of frequencies used by a wireless device part of a WLAN and a WPAN may cause this in-band interference. In particular, in some scenarios, sending a CTS-2-Self frame over the WLAN during a WPAN operational cycle may cause concurrently-transmitted data over the WPAN to be unintelligible or corrupted. The scheme enablement logic 116 of FIG. 1 may determine an SNR value based on one or more of WPAN and WLAN channel/frequency characteristics, antenna isolation characteristics, thermal noise, quantization noise, or gain characteristics of a WPAN front-end (e.g., the WPAN RFFE 112). This SNR value may be used to determine whether the coexistence process described herein (e.g., the coexistence process implemented by the scheme logic 114) is to be enabled. The scheme enablement logic 116 may enable this coexistence process if the SNR value is above a certain SNR threshold. The SNR threshold may be predetermined based on a baseline SNR needed to process a received RX WPAN packet.

To find the SNR value, the scheme enablement logic 116 may calculate an interference value and a WPAN signal strength value. The interference value may represent how much of a WLAN signal transmitted via a WLAN antenna 402 is introduced to an analog-to-digital converter (ADC) of the WPAN front-end. The WPAN signal strength value may represent how much of a WPAN signal transmitted over the WPAN by another wireless device is introduce to the ADC. In at least one embodiment, the scheme enablement logic 116 may determine the interference value based on the following equation (1):

$$Interference = {T}_{WLAN} - i - {P}_{WLAN} ( {f}_{WPAN} ) - M + G dBm \qquad Equation ( 1 )$$

Here, T_{WLAN} represents a transmit power of the WLAN signal, i represents a board level isolation between a WLAN antenna 402 and WPAN antenna 404, P_{WLAN} represents a power level of a transmitted WLAN signal at a frequency, f_{WPAN} represents a frequency used by the WPAN, M represents a margin incorporated into the calculation to ensure that the interference remains within acceptable limits (e.g., accounting for uncertainties, variations, or potential worst-case scenarios), and G represents a gain of the WPAN front-end. In some embodiments, the transmit power of the WLAN signal T_{WLAN} may be lowered when sending CTS-2-Self signals in relation to other WLAN transmissions. This transmit power may be lowered in order to reduce in-band leakage introduced to the WPAN front-end and create more scenarios where the coexistence process implemented by the scheme logic 114 may be used during WPAN operational cycles.

In at least one embodiment, the scheme enablement logic 116 may determine the WPAN signal strength value based on the following equation (2):

$$R = B + G dBm \qquad Equation ( 2 )$$

Here, R is the signal strength value, B is the signal strength of the WPAN signal received at a WPAN antenna 404, and G represents a gain of the WPAN front-end. So, in at least one embodiment, the scheme enablement logic 116 may determine the SNR value according to the following equation (3):

$$SNR = R - I = B - {T}_{WLAN} + i + {P}_{WLAN} ( {f}_{WPAN} ) + M dBm \qquad Equation ( 3 )$$

In some embodiments, some of the above variables are not necessary. For example, the SNR value may be calculated without a margin value M or without the gain G. In some embodiments, the scheme enablement logic 116 may only compare a combination of P_{WLAN} (f_{WPAN}) and the signal strength value R to the SNR threshold. Other embodiments may also incorporate other types of noise to determine the SNR value, such as quantization and thermal noise.

Once the scheme enablement logic 116 has determined the SNR value, the scheme enablement logic 116 compare the SNR value to the SNR threshold. If the SNR value satisfies the threshold, the coexistence process implemented by the scheme logic 114 may be enabled. If the SNR value does not satisfy the threshold, a different coexistence process may be implemented. A purpose of this comparison may be to ensure that in-band leakage caused by transmitting CTS-2-Self frames over the WLAN does not corrupt an RX WPAN packet or otherwise make the RX WPAN packet unintelligible. An unintelligible RX WPAN packet may be a packet with unusable, non-understandable data.

In at least one embodiment, the WLAN module 102 may scale down a transmit (TX) power (e.g., WLAN TX power) while sending these CTS-2-Self frames in order lower the interference value, which in turn enhances the SNR value. However, by lowering the WLAN TX power, the WLAN module 102 may lose communication range. This lost communication range may be regained by the SLAN module 102 choosing a lower modulation technique while sending CTS-2-Self frames.

FIG. 5 is a flowchart illustrating operations of the scheme enablement logic 116, according to one embodiment. The operations of the scheme enablement logic 116 may be performed by processing logic that may comprise hardware (e.g., circuitry, dedicated logic, programmable logic, microcode, etc.), software, firmware, or a combination thereof. In one embodiment, the processing logic may be the host processor 106 of FIG. 1. In another embodiment, the processing logic may be a combination of the WLAN module 102, the WPAN module 104, and the host processor 106 of FIG. 1. In some embodiments, the operations of the scheme enablement logic 116 may be performed by components of the wireless device 100 of FIG. 1 or the wireless device 1000 of FIG. 10. The operations of the scheme enablement logic 116 can be performed by other devices described herein.

At block 502, the scheme enablement logic 116 determines a proximity of WLAN and WPAN channels or operating frequencies. In some embodiments, a center frequency f₀ representing operating frequencies of the WLAN may be compared to an operating WPAN channel frequency. The center frequency of the WLAN channel may be used in this comparison to take advantage of known WLAN spectral masks. These WLAN spectral masks define allowable power distribution across frequency spectrum for a WLAN signal outside of the operating WLAN channel. As such, at decision block 504, these WLAN spectral masks may be used as a reference to determine, based on proximity of a center frequency f₀ of the WLAN operating channel and the WPAN operating channel, whether the scheme enablement logic 116 should calculate an SNR value, as described above in FIG. 4. If this center frequency f₀ and WPAN operating channel are far enough apart, the scheme enablement logic 116 can skip calculating the SNR value and comparing it to the SNR threshold and enable the coexistence process (e.g., the first coexistence process) implemented by the scheme logic 114. This center frequency f₀ and WPAN operation channel may be far enough apart if they are separated by a threshold frequency gap (e.g., 30 MHz, 25 MHz, 20 MHz). This threshold frequency gap may be dependent on a bandwidth of the WLAN operating channel. However, if the center frequency f₀ and WPAN operation channel are closer in proximity, the scheme enablement logic 116 may determine whether in-band leakage caused by a CTS-2-Self frame would have a significant likelihood to corrupt an RX WPAN packet at decision block 506.

At decision block 506, the scheme enablement logic 116 may determine an SNR value and compare it to an SNR threshold, as described above with respect to FIG. 4. If the SNR value satisfies the SNR threshold, a CTS-2-Self frame transmitted during a WPAN operational cycle does not have a significant likelihood to corrupt an RX WPAN packet. In this scenario, the scheme enablement logic 116 may enable the first coexistence process for the current WPAN operational cycle at block 510. If the SNR value does not satisfy the SNR threshold, a CTS-2-Self frame transmitted during a WPAN operational cycle does have a significant likelihood to corrupt an RX WPAN packet. In this scenario, the scheme enablement logic 116 may enable a different coexistence process (e.g., the second coexistence process) for the current WPAN operational cycle at block 508. This different coexistence process may use a different coexistence technique that does not involve transmitting CTS-2-Self frames over the WLAN during the WPAN operational cycle (i.e., so RX WPAN packets are not corrupted by in-band leakage caused by the CTS-2-Self frames).

At block 512, the scheme enablement logic 116 may wait for a next WPAN operational cycle. The scheme enablement logic 116 may determine which coexistence process should be used once per each WPAN operational cycle. In at least one embodiment, one or more of the operations of the scheme enablement logic 116 may occur before a WPAN operational cycle has actually begun. For example, one or more operations of the scheme enablement logic 116 may occur during a preceding WLAN operational cycle.

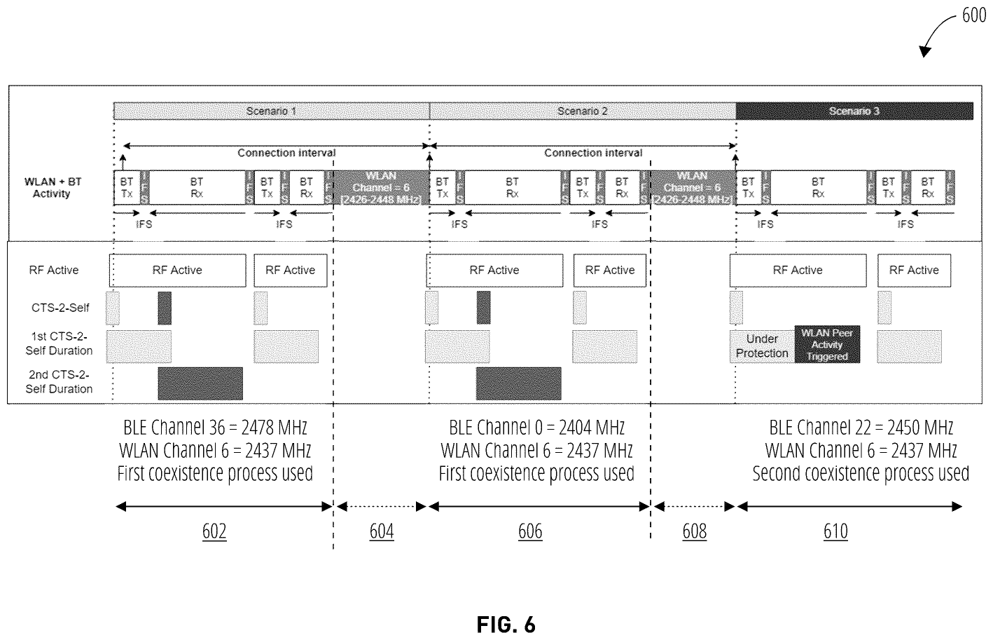

FIG. 6 depicts an exemplary graph 600 illustrating outcomes of the scheme enablement logic 116, according to one embodiment. While the graph 600 uses Bluetooth Low Energy® (BLE®) as an exemplary WPAN, any other type of WPAN or other type of suitable network may be used. The graph 600 illustrates a wireless device (e.g., the wireless device 100) switching between WPAN operational cycles 602, 606, 610 and WLAN operational cycles 604, 608. Illustrated CTS-2-Self frame durations may correspond to the WPAN operational cycles. These CTS-2-Self frame durations may represent durations set to the NAVs of other devices of the WLAN by a CTS-2-Self frame.

In the illustrated exemplary graph 600, the wireless device is configured to transmit frames over the WLAN on channel 6, which spans from 2426-2448 MHz. WLAN channel 6 has a center frequency f₀ of 2437 MHz. At the first WPAN operational cycle 602, the WPAN is set to BLE® channel 36, which has a frequency of 2478 MHz. The difference between the center frequency f₀ of WLAN channel 6 and the BLE® channel 36 frequency is 41 MHz, which means that a CTS-2-Self frame transmitted over WLAN channel 6 would cause minimal in-band leakage within BLE® channel 36. As such, the coexistence process implemented by the scheme logic 114 (also referred to as the first coexistence process) as described herein may be enabled and used during the first WPAN operational cycle 602. Similarly, at the second WPAN operational cycle 606, the WPAN is set to BLE® channel 0, which has a frequency of 2404 MHz. The difference between the center frequency f₀ of WLAN channel 6 and the BLE® channel 36 frequency is 33 MHz, which means that a CTS-2-Self frame transmitted over WLAN channel 6 would cause minimal in-band leakage within BLE® channel 0. As such, the first coexistence process may also be enabled and used during the second WPAN operational cycle 606.

At the third WPAN operational cycle 610, the WPAN is set to BLE® channel 22, which has a frequency of 2450 MHz. The difference between the center frequency f₀ of WLAN channel 6 and the BLE® channel 36 frequency is 13 MHz, which means that a CTS-2-Self frame transmitted over WLAN channel 6 could cause significant in-band leakage within BLE® channel 22. As such, at least in this scenario (and in some embodiments for the first and second WPAN operational cycles 602, 604 as well), the scheme enablement logic 116 may calculate an SNR value using the WLAN and WPAN channel characteristics as described above with respect to FIG. 4 and make a decision about which coexistence process should be used during the third WPAN operational cycle 610. In the event that the SNR value does not satisfy the SNR threshold, a different coexistence process (also referred to as a second coexistence process herein) may be enabled and used during the third WPAN operational cycle 610.

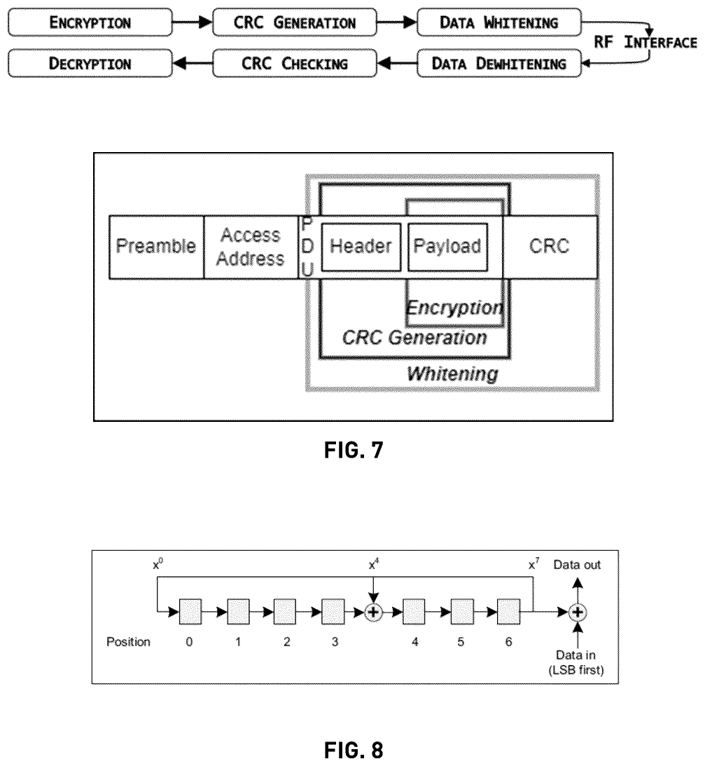

FIG. 7 illustrates a process of encryption, cyclic redundancy check (CRC) generation, and data whitening from transmit (TX) and receive (RX) sides of a wireless communication, according to one embodiment. This process may be implemented to generate data packets for a WLAN or a WPAN. On the TX side, a payload of the data packet may first be encrypted. In at least one embodiment, the payload is encrypted using an encryption key. The encryption key is generated based on a combination of factors including, but not limited to, the sender's and receiver's identities, a timestamp, and a random number. This can help ensure the uniqueness and security of the key. The encryption key is applied to the payload of the data packet using an encryption algorithm (e.g., advanced encryption standard (AES), Rivest-Shamir-Adleman (RSA)). The choice of algorithm may vary based on the required security level and processing capabilities.

After encryption, a header may be attached to the encrypted payload. A header typically is metadata that provides information for the correct handling and routing of the packet. Typically positioned at the beginning of the packet, the header contains a variety of fields that are used by networking devices to ensure the data reaches its intended destination efficiently and accurately. The type of information in a header generally includes a length value that indicates a size of the payload (encrypted or not encrypted). The header may also include source and destination Internet Protocol (IP) addresses, which allow routers and switches to determine the correct path for the packet through the network. Additionally, headers often include sequence numbers and acknowledgment numbers for managing data flow and ensuring reliable delivery in protocols like TCP (Transmission Control Protocol). Other common fields in a packet header can include the protocol type, which indicates the higher-level protocol being used (such as TCP, user datagram protocol (UDP), or internet control message protocol (ICMP)), and port numbers, which help direct the packet to the appropriate application or service on the receiving device. Headers can also contain flags and control information, such as those indicating packet fragmentation or priority levels, which are vital for handling different types of network traffic appropriately. Once the header is attached to the payload, a CRC may be generated using the combined header and encrypted payload. CRC generation is used in digital communications and storage devices to detect accidental changes to raw data. It involves appending a sequence of redundant bits, known as the CRC code or checksum, to a message. This checksum may be appended to the combined header and encrypted payload as a footer, as illustrated. This checksum is calculated using a predefined polynomial, known as the generator polynomial, which is applied to the message data. The process starts by treating the data as a binary number and then performing binary division by the generator polynomial, using XOR operations instead of subtraction. The remainder of this division, after the entire message has been processed, becomes the CRC value. When a message with its CRC code is transmitted or stored, the receiver or storage system can perform the same division process on the received data, including the appended CRC. If the remainder is zero, it indicates that the data has likely been received or read correctly. If not, it suggests that an error has occurred.

The combined header, encrypted payload, and checksum are then passed through a data whitening process. Data whitening is a technique used to transform input data into a more uniform distribution to reduce the likelihood of long sequences of identical bits, which can cause issues in data transmission and storage. By applying a whitening algorithm, typically (but not necessarily) involving XOR operations with a pseudorandom sequence, the data becomes more randomized, helping to minimize signal interference and improve error detection. This data whitening process may be similar to what is described below in FIG. 8.

Once whitened, the combined header, encrypted payload, and checksum are transmitted over a radio frequency (RF) medium and received by a different wireless device. A preamble and access address may be appended to the packet before being transmitted over the RF medium. Once received, the process used to prepare the signal for transmission over the RF medium may be performed in reverse. For example, a first step of processing the received packet may be de-whitening the received packet. Data de-whitening is the process of reversing the data whitening transformation to retrieve the original data from its whitened form. This is achieved by applying the same pseudorandom sequence (or other technique) used during whitening, to decode the transmitted or stored data back to its original state. Once de-whitened, information from the header may be intelligible and used to send the second CTS-2-Self frame (or determine not to send a second CTS-2-Self frame), as described herein. After de-whitening, the combined header, encrypted payload, and appended checksum may be divided (e.g., binary division) by the same predefined polynomial used to generate the checksum. If the remainder of this division is zero, it indicates that the packet as been transmitted correctly without errors. If the remainder is not zero, the packet was not received without errors. After the CRC checking, the payload may be decrypted and processed.

FIG. 8 illustrates a linear feedback shift register (LFSR) of a data whitening process, according to one embodiment. An LFSR is a generally used for data whitening, which aims to randomize the data pattern to avoid long sequences of identical bits that can cause issues in transmission and storage. An LFSR includes at least a shift register and a feedback function defined by a polynomial. The shift register can be a series of flip-flops that hold the bits of the data, and the feedback function determines how the bits are shifted and combined. In the data whitening process, the LFSR takes the input data and sequentially shifts it through the register. At each step, the bits are shifted to the right, and a new bit is introduced at the leftmost position based on the feedback function. The feedback function typically involves XOR operations between selected bits of the register, defined by the feedback polynomial. The resulting sequence from the LFSR is then XORed with the original data to produce the whitened data. This process can help ensure that the output data has a more uniform distribution of bits, reducing the likelihood of transmission errors and improving the robustness of the communication system.

In some embodiments, the LFSR may be a 7-bit LFSR. In a 7-bit LFSR, each bit in the original data is influenced by a combination of bits that have passed through the register in previous cycles. Thus, the feedback function of a 7-bit LFSR can ensure that the current state of the register is a function of the previous 7 bits that were input. Therefore, to accurately de-whiten or reconstruct a particular bit of the original data, the system must process the subsequent 7 bits. This is because the effect of the feedback mechanism and the bitwise interactions need to be reversed for those 7 bits to recover the original state and correctly determine the original value of the specific bit. So, when a 7-bit LFSR is used, at least 7 bits subsequent to bits representing the length value of the packet may be required before the length value is intelligible and usable by one or more of the scheme logic 114.

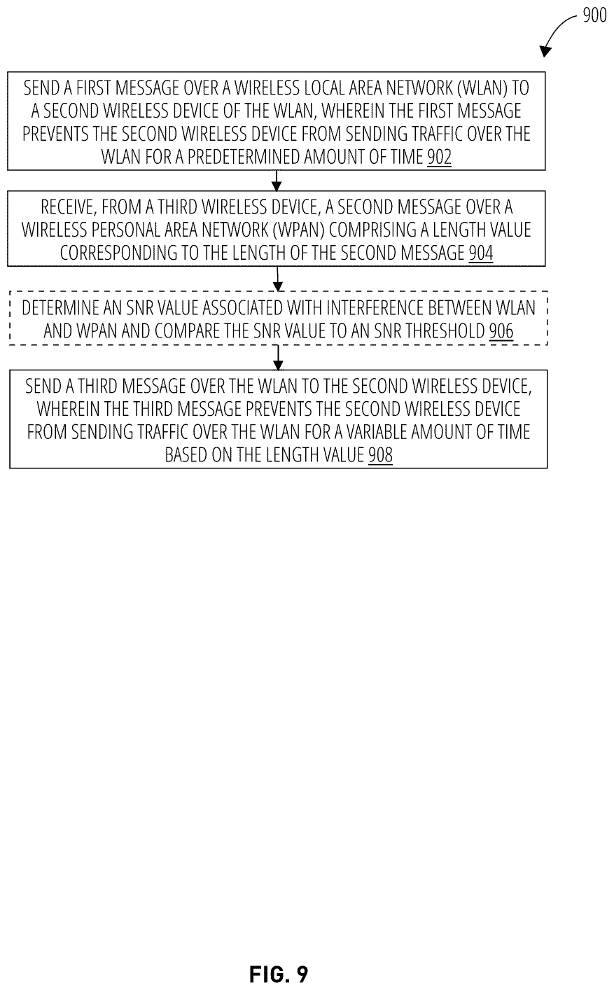

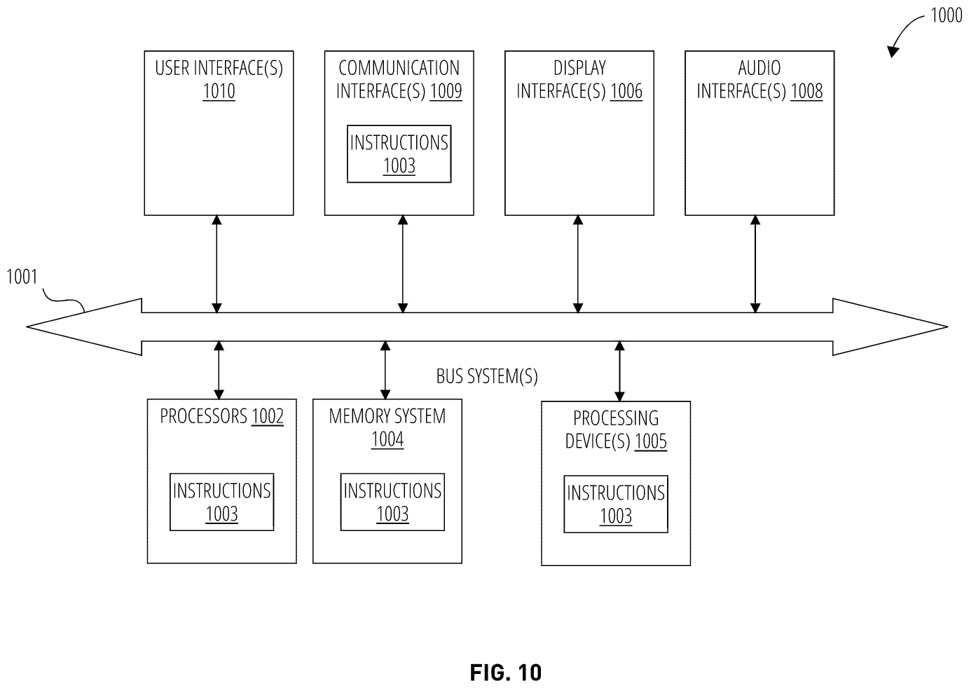

FIG. 9 is a method 900 of performing a coexistence process, according to one embodiment. The method 900 may be performed by processing logic that may comprise hardware (e.g., circuitry, dedicated logic, programmable logic, microcode, etc.), software, firmware, or a combination thereof. In one embodiment, the processing logic may be the host processor 106 of FIG. 1. In another embodiment, the processing logic may be a combination of the WLAN module 102, the WPAN module 104, and the host processor 106 of FIG. 1. In some embodiments, the method 900 may be performed by components of the wireless device 100 of FIG. 1 or the wireless device 1000 of FIG. 10. The method 900 can be performed by other devices described herein.

At block 902, the processing logic may send a first message via a first protocol to a second wireless device. The first message may prevent the second wireless device from sending traffic over the WLAN for a predetermined amount of time. This first protocol may correspond to a wireless local area network (WLAN), or a different type of network.

At block 904, the processing logic may receive a second message via a second protocol from a third wireless device. This second message may include a length value corresponding to the length of the second message. This second protocol may correspond to a wireless personal area network (WPAN) or a different type of network.

At block 906, the processing logic may determine an SNR value associated with interference between networks corresponding to the first and second protocols. The processing logic may compare this SNR value to an SNR threshold. In at least one embodiment, the operations of block 906 are optional.

At block 908, the processing logic may send a third message via the first protocol. In at least one embodiment, the third message may be sent in response to the SNR value satisfying the SNR threshold. This third message may prevent the second wireless device from sending traffic via the first protocol for a variable amount of time based on the length value.

FIG. 10 is a block diagram illustrating a wireless device 1000, according to one embodiment. The wireless device 1000 may fully or partially include and/or operate the example embodiments of the wireless device 100 or portions thereof as described with respect to FIGS. 1-8. The wireless device 1000 may be in the form of a computer system within which sets of instructions may be executed to cause the wireless device 1000 to perform any one or more of the methodologies discussed herein. The wireless device 1000 may operate as a standalone device or may be connected (e.g., networked) to other machines. In a networked deployment, the wireless device 1000 may operate in the capacity of a server or a client machine in server-client network environment, or as a peer machine in a P2P (or distributed) network environment.

The wireless device 1000 may be an Internet of Things (IoT) device, a server computer, a client computer, a personal computer (PC), a tablet, a set-top box (STB), a voice controlled hub (VCH), a Personal Digital Assistant (PDA), a mobile telephone, a web appliance, a network router, switch or bridge, a television, speakers, a remote control, a monitor, a handheld multi-media device, a handheld video player, a handheld gaming device, or a control panel, or any other machine capable of executing a set of instructions (sequential or otherwise) that specify actions to be taken by that machine. Further, while only a single wireless device 1000 is illustrated, the term “device” shall also be taken to include any collection of machines that individually or jointly execute a set (or multiple sets) of instructions to perform any one or more of the methodologies discussed herein.

The wireless device 1000 is shown to include processor(s) 1002. In embodiments, the wireless device 1000 and/or processors(s) 1002 may include processing device(s) 1005 such as a System on a Chip (SoC) processing device. Alternatively, the wireless device 1000 may include one or more other processing devices known by those of ordinary skill in the art, such as a microprocessor or central processing unit, an application processor, a host controller, a controller, special-purpose processor, digital signal processor (DSP), an application specific integrated circuit (ASIC), a field programmable gate array (FPGA), or the like. Bus system 1001 may include a communication block (not shown) to communicate with an internal or external component, such as an embedded controller or an application processor, via communication interfaces(s) 1009 and/or bus system 1001.

Components of the wireless device 1000 may reside on a common carrier substrate such as, for example, an integrated circuit (IC) die substrate, a multi-chip module substrate, or the like. Alternatively, components of the wireless device 1000 may be one or more separate ICs and/or discrete components.

The memory system 1004 may include volatile memory and/or non-volatile memory which may communicate with one another via the bus system 1001. The memory system 1004 may include, for example, random access memory (RAM) and program flash. RAM may be static RAM (SRAM), and program flash may be a non-volatile storage, which may be used to store firmware (e.g., control algorithms executable by processor(s) 1002 to implement operations described herein). The memory system 1004 may include instructions 1003 that when executed perform the methods described herein. Portions of the memory system 1004 may be dynamically allocated to provide caching, buffering, and/or other memory based functionalities.

The memory system 1004 may include a drive unit providing a machine-readable medium on which may be stored one or more sets of instructions 1003 (e.g., software) embodying any one or more of the methodologies or functions described herein. The instructions 1003 may also reside, completely or at least partially, within the other memory devices of the memory system 1004 and/or within the processor(s) 1002 during execution thereof by the wireless device 1000, which in some embodiments, constitutes machine-readable media. The instructions 1003 may further be transmitted or received over a network via the communication interfaces(s) 1009. The communication interface(s) 1009 may be where the wireless device 100 discussed herein is implemented and/or located. In at least one embodiment, the communication interface(s) 1009 may include at least the WLAN module 102 and WPAN module 104, as described herein.

While a machine-readable medium is in some embodiments a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the example operations described herein. The term “machine-readable medium” shall accordingly be taken to include, but not be limited to, solid-state memories, and optical and magnetic media.

The wireless device 1000 is further shown to include display interface(s) 1006 (e.g., a liquid crystal display (LCD), touchscreen, a cathode ray tube (CRT), and software and hardware support for display technologies), audio interface(s) 1008 (e.g., microphones, speakers and software and hardware support for microphone input/output and speaker input/output). The wireless device 1000 is also shown to include user interface(s) 1010 (e.g., keyboard, buttons, switches, touchpad, touchscreens, and software and hardware support for user interfaces).

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “detecting,” “comparing,” “resetting,” “adding,” “calculating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMS, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the embodiments should, therefore, be determined with reference to the appended claims, along with the full scope of equivalents to which such claims are entitled.

What is claimed is:

1. A method of operating a first wireless device, the method comprising:
receiving, by a first protocol of the first wireless device, a first message comprising a length value corresponding to a length of the first message;
obtaining, by a second protocol of the first wireless device, the length value; and
sending a second message via the second protocol to a second wireless device, wherein the second message prevents the second wireless device from sending traffic via the second protocol for an amount of time based on the length value.

2. The method of claim 1, wherein the amount of time is based on a payload of the first message.

3. The method of claim 1, further comprising determining, before sending the second message, a signal to noise ratio (SNR) value indicative of interference between networks corresponding to the first and second protocols.

4. The method of claim 3, wherein sending the second message is in response to the SNR value satisfying an SNR threshold.

5. The method of claim 3, wherein determining the SNR value comprises:
determining a signal strength value associated with a strength of connection between the first and second wireless devices;
determining an interference value associated with a proximity between a first frequency used to send the first message and a second frequency associated with the second protocol; and
combining the signal strength value and the interference value.

6. The method of claim 1, wherein the first message is received from a third wireless device, and wherein the method further comprises:
before receiving the first message, tracking historical cyclic redundancy check (CRC) statuses of one or more historical messages received from the third wireless device via the first protocol; and
determining, based on the historical messages, that a CRC threshold is satisfied, wherein the amount of time is based on the length value in response to the CRC threshold being satisfied.

7. The method of claim 1, wherein the first protocol corresponds to a wireless personal area network (WPAN) and the second protocol corresponds to a wireless local area network (WLAN).

8. A first wireless device, comprising:
a wireless personal area network (WPAN) module; and
a wireless local area network (WLAN) module, wherein the WLAN module is to:
obtain, from the WPAN module, a length value of a first message, wherein the length value indicates a length of the first message; and
send a second message over a wireless local area network (WLAN) to a second wireless device, wherein the second message prevents the second wireless device from sending traffic over the WLAN for an amount of time based on the length value.

9. The first wireless device of claim 8, wherein the amount of time is based on a payload of the second message.

10. The first wireless device of claim 8, wherein the WLAN module is further to determine, before sending the second message, a signal to noise ratio (SNR) value associated with interference between the WLAN and WPAN.

11. The first wireless device of claim 10, wherein sending the second message is in response to the SNR value satisfying an SNR threshold.

12. The first wireless device of claim 10, wherein to determine the SNR value, the WLAN module is further to:
determine a signal strength value associated with a strength of connection between the first and second wireless devices;
determine an interference value associated with a proximity between a first frequency used to send the first message and a second frequency associated with the WLAN; and
combine the signal strength value and the interference value.

13. The first wireless device of claim 8, wherein the first message is sent to the first wireless device by a third wireless device, and wherein the first wireless device is to:
before receiving the first message, track historical cyclic redundancy check (CRC) statuses of one or more historical messages received from the third wireless device over the WPAN; and
determine, based on the historical messages, that a CRC threshold is satisfied, wherein the amount of time is based on the length value in response to the CRC threshold being satisfied.

14. A method of operating a first wireless device, the method comprising:
sending a first message via a first protocol to a second wireless device, wherein the first message prevents the second wireless device from sending traffic over a network corresponding to the first protocol for a predetermined amount of time;
receiving, from a third wireless device, a second message via a second protocol comprising a length value corresponding to the length of the second message; and
sending a third message via the first protocol to the second wireless device, wherein the third message prevents the second wireless device from sending traffic via the first protocol for a variable amount of time based on the length value.

15. The method of claim 14, wherein the predetermined amount of time is based on a minimum possible length of the second message, and wherein the variable amount of time is based on a payload of the second message.

16. The method of claim 14, comprising determining, before sending the third message, a signal to noise ratio (SNR) value associated with interference between networks corresponding to the first and second protocols.

17. The method of claim 16, wherein sending the third message is in response to the SNR value satisfying an SNR threshold.

18. The method of claim 16, wherein determining the SNR value comprises:
determining a signal strength value associated with a strength of connection between the first and third wireless devices;
determining an interference value associated with a proximity between a first frequency used to send the second message and a second frequency used to send the first message; and
combining the signal strength value and the interference value.

19. The method of claim 14, further comprising:
before receiving the second message, tracking cyclic redundancy check (CRC) statuses of one or more historical messages received from the third wireless device via the second protocol; and
determining, based on the historical messages, that a CRC threshold is satisfied, wherein the variable amount of time is based on the length value in response to the CRC threshold being satisfied.

20. The method of claim 14, wherein the first protocol corresponds to a wireless personal area network (WPAN) and the second protocol corresponds to a wireless local area network (WLAN).
